(19) United States
(12) Patent Application Publication
(10) Pub. No.: US 2015/0296480 A1
(43) Pub. Date: Oct. 15, 2015

(54) SYSTEMS AND METHODS FOR CONFIGURING VIBRATION PATTERNS FOR NOTIFICATIONS RECEIVED AT A WEARABLE COMMUNICATION DEVICE

(71) Applicant: SilverPlus, Inc., Irvine, CA (US)

(72) Inventors: Stanley Kinsey, Irvine, CA (US); Jefferson Hu, Irvine, CA (US); John Huang, Irvine, CA (US); Peter Khotpanya, Irvine, CA (US)

(21) Appl. No.: 14/684,050

(22) Filed: Apr. 10, 2015

Related U.S. Application Data
(60) Provisional application No. 61/977,829, filed on Apr. 10, 2014.

(51) Int. Cl. H04W 68/00; H04W 4/00

(52) U.S. Cl. CPC H04W 68/00; H04W 4/008

(57) ABSTRACT

Systems, methods, and devices for generating a notification by wearable communication device. One system includes a mobile communication device and a wearable communication device. The mobile communication device includes a display, a first transceiver, and a first processor. The first processor is configured to provide access to a graphical user interface through the display, receive a message type and a vibration pattern for the message type from a user through the graphical user interface, and, when the mobile communication device obtains a message have the message type, transmit a notification to a wearable communication device using the first transceiver. The wearable communication device includes a second transceiver configured to receive the notification, a vibrate motor, and a second processor. The second processor is configured to perform the vibration pattern using the vibrate motor in response to receiving the notification.

### RELATED APPLICATIONS

This application claims priority to U.S. Provisional Patent Application No. 61/977,829 filed Apr. 10, 2014, the entire content of which is incorporated by reference herein.

### BACKGROUND

Embodiments of the present invention relate to providing notifications on a wearable communication device and configuration vibration patterns for such notifications.

### SUMMARY

When a user receives a message at a mobile communication device, such as a smart phone, it can sometimes be difficult for the user to locate or access the device. Therefore, a user may wear a wearable communication device that communicates with the mobile communication device and, therefore, can inform the user of messages received at the mobile communication device. To keep these types of notification discrete, the user may set notifications provided through the wearable communication to vibration. It would be useful for the user to use the vibration notification to quickly identify the type of message received at the mobile communication device or the source of the message received at the mobile communication device (e.g., a particular caller). However, wearable communication devices often have limited functionality as compared to mobile communication devices and are often difficult to configure given the small display and often limited input elements available on the wearable communication device.

Accordingly, in one embodiment, the invention provides a wearable communication device. The wearable communication device includes an attachment device configured to couple the wearable communication device to a user, a short-range wireless transceiver configured to communicate with a mobile communication device, a vibrate motor, and a processor. The processor is configured to receive from the mobile communication device, through the wireless transceiver, a first vibration pattern and a first message type associated and a second vibration pattern and a second message type associated with the second vibration pattern. The processor is configured to store the first vibration pattern and the associated first message type and the second vibration pattern and the associated second message type in memory included in the wearable communication device. The processor is also configured to receive a message from the mobile communication device through the wireless transceiver. When a type of the received message is the first type, the processor is configured to access the stored first vibration pattern and operate the vibrate motor according to the first vibration pattern. When the type of the received message is the second type, the processor is configured to access the stored second vibration pattern and operate the vibrate motor according to the second vibration pattern.

In another embodiment, the invention provides a method of generation a notification by a wearable communication device. The method includes receiving from a user, by a mobile communication device, a first vibration pattern for a first message type and a second vibration pattern for a second message type and storing, by the mobile communication device, the first vibration pattern associated with the first message type and the second vibration pattern associated with the second message type. The method also includes, receiving, by the mobile communication device, a message, determining, by the mobile communication device, a type of the received message, and transmitting a command to the wearable communication device. When the type of the received message is the first type, the command instructs the wearable communication device to perform the first vibration pattern and, when the type of the received message is the second type, the command instructs the wearable communication device to perform the second vibration pattern. The association between the first vibration pattern and the first message type and the association between the second vibration pattern and the second message type is not stored on the wearable communication device.

In yet another embodiment, the invention provides a communication system. The communication system includes a mobile communication device and a wearable communication device. The mobile communication device includes a display, a first transceiver, and a first processor. The first processor is configured to provide access to a graphical user interface through the display, receive a message type from a user through the graphical user interface, receive a vibration pattern for the message type from the user through the graphical user interface, and, when the mobile communication device obtains a message have the message type, transmit a notification to a wearable communication device using the first transceiver. The wearable communication device includes a second transceiver configured to receive the notification, a vibrate motor, and a second processor. The second processor is configured to perform the vibration pattern using the vibrate motor in response to receiving the notification.

Other aspects of the invention will become apparent by consideration of the detailed description and accompanying drawings.

### BRIEF DESCRIPTION OF THE DRAWINGS

FIG. 1 schematically illustrates a wireless communication system according to one embodiment of the invention.

FIG. 2 schematically illustrates a mobile communication device included in the wireless communication system of FIG. 1.

FIGS. 3 and 3A are screenshots of a graphical user interface provided by the mobile communication device of FIG. 2.

FIG. 4 is a flowchart illustrating a method of providing a vibration pattern notification using the wireless communication system of FIG. 1.

FIG. 5 is a flowchart illustrating an alternative method of providing a vibration pattern notification using the wireless communication system of FIG. 1.

FIG. 6 is a front view of the wearable communication device included in the wireless communication system of FIG. 1.

FIG. 7 schematically illustrates the wearable communication device of FIG. 6.

### DETAILED DESCRIPTION

Before any embodiments of the invention are explained in detail, it is to be understood that the invention is not limited in its application to the details of the configuration and arrangement of components set forth in the following description or illustrated in the accompanying drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, electronic components or modules, or combinations thereof that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components may be utilized to implement the invention. For example, “communication devices,” “computers,” and “servers” described in the specification can include one or more processing units, one or more computer-readable medium modules, one or more input/output interfaces, and various connections (e.g., a system bus) connecting the components. Also, the term “automatically” as used in the present application indicates functionality performed by software modules (executed by a processing unit) and/or hardware components without manual intervention.

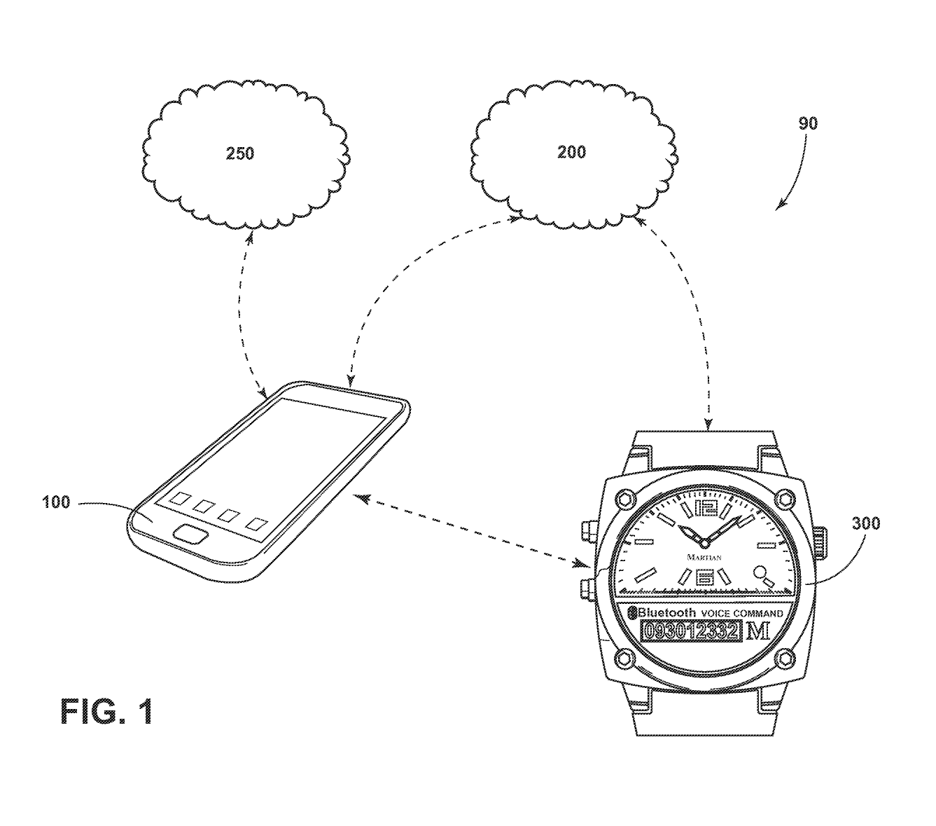

FIG. 1 illustrates a wireless communication system 90. The wireless communication system 90 includes a mobile communication device 100 and a wearable communication device 300. The wearable communication device 300 and the mobile communication device 100 wirelessly communication over a first network 200. In some embodiments, the first network 200 provides communication using short-range signals. The first network 200 can include a Bluetooth connection (including Bluetooth low energy), a local area network (e.g., a Wi-Fi network), the Internet, etc. In some embodiments, the mobile communication device also wirelessly communicates over a second network 250. For example, the mobile communication device 100 can be configured to receive messages from other sources (e.g., other mobile communication devices, telephones, servers, etc.) over the second network 250, which can include a cellular network, the Internet, a local area network (e.g., a Wi-Fi network), etc. It should be understood that, in some embodiments, the mobile communication device 100 also communicates with the wearable communication device 300 through the second network 250. Also, in some embodiments, the mobile communication device 100 only communicates through a signal network rather than two networks. Similarly, in some embodiments, the mobile communication device 100 and/or the wearable communication device 300 can communicate over additional networks.

The mobile communication device 100 communicates with the wearable communication device 300 to alert a user wearing the device 300 when a message has been received by the mobile communication device 100. As used in the present application, the term “message” includes a telephone call (with sound or sound and video), a voicemail message, an email message, a text message, an application notification (e.g., associated with an application executed by the mobile communication device 100, such as a game, Facebook, LinkedIn, etc.), or any other message received or generated by the mobile communication device 100 (e.g., a status message indicating a status of the device 100, such as whether the device 100 needs an update, whether a battery power of the device 100 is low, or whether the device 100 has lost a connection with the second network 250. Providing the notification through the wearable communication device 300 quickly informs the user of the message (e.g., without the user having to locate or retrieve the mobile communication device 100) and allows the user to promptly respond to the message as needed.

The mobile communication device 100 can be a smartphone, a tablet computer, a laptop computer, a cellular phone, or any other electronic device capable of sending and receiving wireless signals (e.g., short range signals) to and from the wearable communication device 300. In the embodiment illustrated in FIG. 1, the mobile communication device 100 is a smartphone.

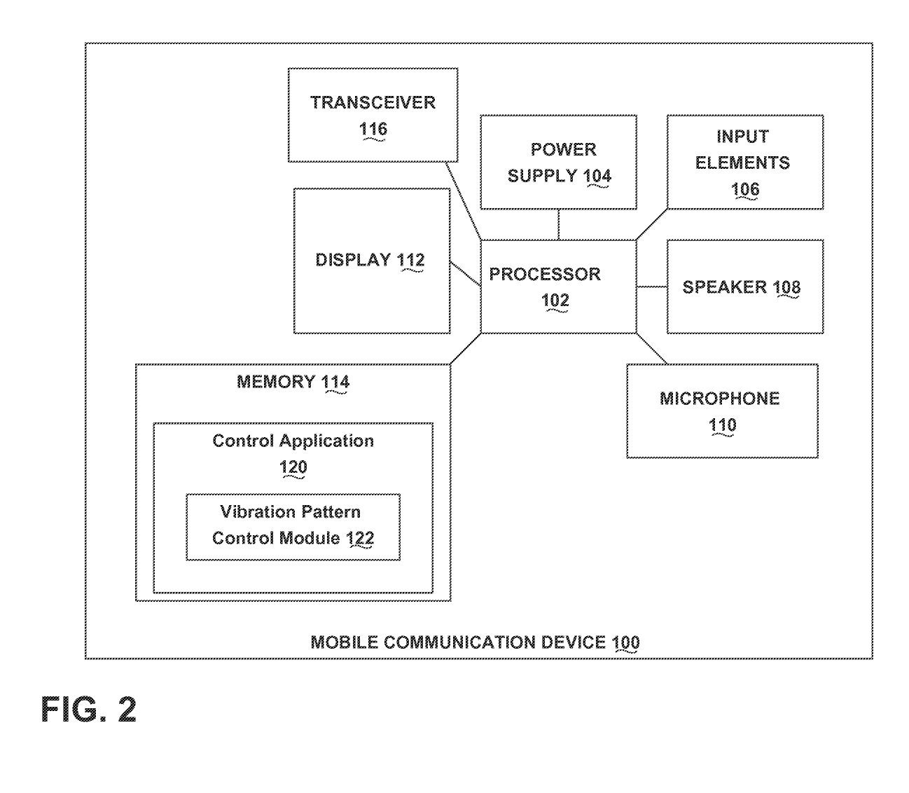

As shown in FIG. 2, the mobile communication device 100 includes a processor 102, a power supply 104, input elements 106, a speaker 108, a microphone 110, a display 112, memory 114, and a transceiver 116. The power supply 104 provides power to components of the mobile communication device 100. The power supply 104 can be a replaceable and/or rechargeable battery. The transceiver 116 is configured to receive signals from and send signals to the second network 250 and receive signals from and send signals to the first network 200. In some embodiments, the transceiver 116 can be configured to receive signals from and send signals to the first network 200 and a separate transceiver included in the mobile communication device 100 can be configured to receive signals from and send signal to the second network 250.

The microphone 110 included in the mobile communication device 100 is used to receive sound signals (e.g., from the user). The sound signals received through the microphone 110 can be used by the mobile communication device 100 as instructions (e.g., as voice commands or dictation instructions), or the sounds signals can be transmitted to another electronic device, such as, for example, a second mobile communication device (e.g., as a voice call or message). The speaker 108 allows the mobile communication device 100 to output sound signals to a user. For example, the speaker 108 can be used to alert a user when a message has been received by the mobile communication device 100 or present a message to a user (e.g., as a voice call or message). The speaker 108 can also be used to alert a user of a status (e.g., low battery) of the mobile communication device 100.

The display 112 included in the mobile communication device 100 displays information to a user, such as in the form of a graphical user interface. The input elements 106 allow the user to interact with the mobile communication device 100 including information displayed on the display 112. The input elements 106 can include buttons, switches, sensors (e.g., a touchscreen), digital buttons, etc.

The memory 114 included in the mobile communication device 100 includes a non-transitory computer-readable medium storing instructions executed by the processor 102 and associated data. In the illustrated embodiment, the memory 114 stores a control application 120 associated with the wearable communication device 300. In some embodiments, the control application 120 can be stored and executed directly on the mobile communication device 100. In other embodiments, the mobile communication device 100 can connect to a remote memory (e.g., included in a server accessible over the second network 250) to access and interact with the control application 120. In yet other embodiments, some aspects of the control application 120 are hosted by the mobile communication device 100 and other aspects of the control application 120 are remotely accessible. It should be understood that the memory 114 can also store other applications accessed by the user through the mobile communication device 100. These applications can be communication applications that enable communication with other mobile communication devices, social applications, or can be related to news, weather, fitness, sports, earthquakes and other natural disasters, banking, and the like.

The processor 102 is coupled to the power supply 104, the input elements 106, the speaker 108, the microphone 110, the display 112, memory 114, and the transceiver 116. The processor 102 is configured (i.e., through executing instructions) to receive messages through the transceiver 116. The processor 102 can also be configured to generate status messages (e.g., low battery power, connection with second network 250 lost, etc.). In response to a message, the processor 203 can be configured to determine (1) whether to alert a user of the message through the mobile communication device 100 and (2) whether to alert a user of the message through the wearable communication device 300. In some embodiments, these decisions can be merged such that if the user is alerted of a message through the mobile communication device 100, the user is by default, also alerted of the message through the wearable communication device 300. However, in some embodiments, a user can be alerted to certain message types only through the wearable communication device 300 or only through the mobile communication device 100.

In some embodiments, the control application 120 handles communication between the mobile communication device 100 and the wearable communication device 300. For example, the control application 120 can be configured to process messages and determine whether a notification of the message should be transmitted to the wearable communication device 300. If the control application 120 determines that a notification should be transmitted, the control application 120 can generate and transmit the notification to the wearable communication device 300. The notification can include the message type and other information associated with the message (e.g., a sender, a received time, a size, a length, etc.). In some embodiments, the notification also includes the received message. Alternatively, if the notification does not include the received message, the wearable communication device 300 can use the received notification to access the message (e.g., if requested by the user) by communicating with the mobile communication device 100. It some embodiments, one or more applications separate from the control application 120 handle the generation and transmission of notifications to the wearable communication device 300.

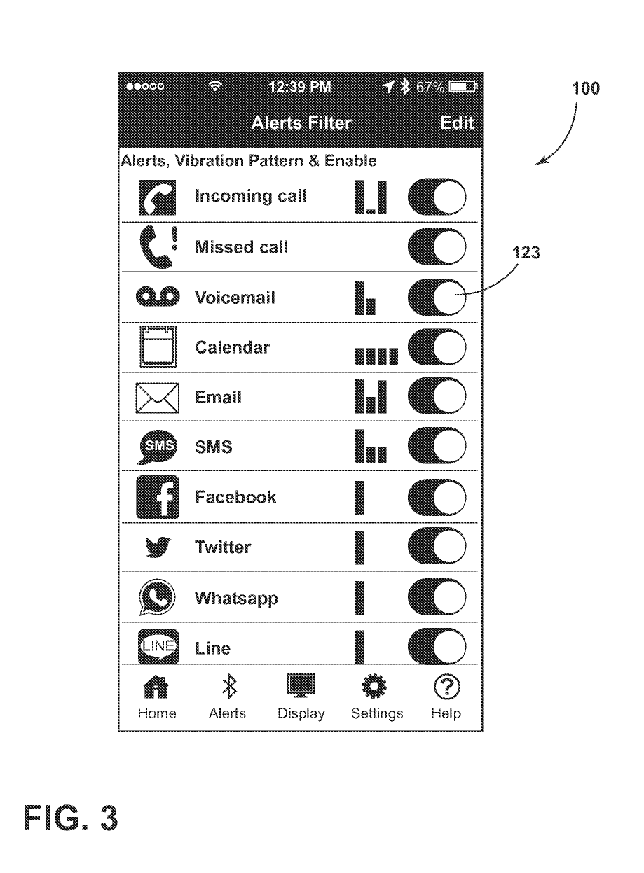

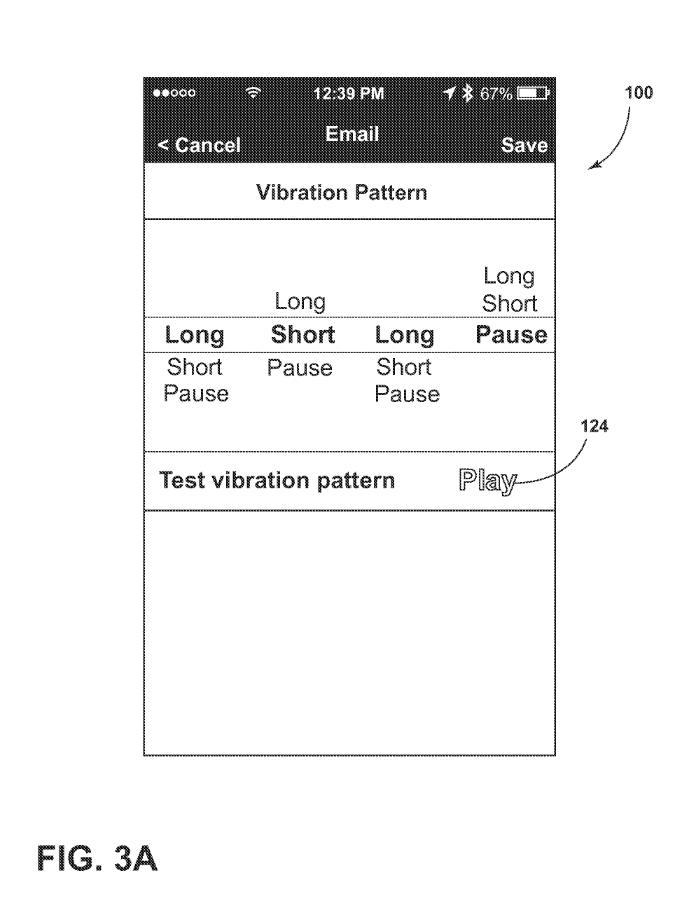

FIGS. 3 and 3A illustrate a graphical user interface generated through the control application 120. In particular, the control application 120 can include a vibration pattern control module 122 that generates the user interface illustrated in FIGS. 3 and 3A. The user interface illustrated in FIGS. 3 and 3A allows a user to (1) set whether a notification should be transmitted to the wearable communication device 300 for a particular message type and (2) set a vibration pattern for notifications for a particular message type. As illustrated in FIG. 3, the graphical user interface can display a list of message types. An activation button 123 can be associated with each message type. A user can select the activation button 123 to specify whether a notification should be sent to the wearable communication device 300 for a particular message type.

The graphical user interface can also allow a user to set or modify a vibration pattern for a particular message type. For example, as illustrated in FIG. 3, a bar graph can be displayed next to a message type. The bar graph represents a vibration pattern associated with a particular message type. As illustrated in FIG. 3, some message types may not have an assigned vibration pattern, such as a missed call message. A vibration pattern can include one or more pluses and a length assigned to each pulse. For example, in the embodiment illustrated in FIG. 3, a message type can be assigned a vibration pattern that includes four pulses. Each vibration pulse can be set to a particular length. For example, in some embodiments, a user can set each pulse to a long vibration, a short vibration, or a pause (i.e., no vibration). Accordingly, as illustrated in FIG. 3, the bar graph displayed for a message type can indicate the vibration length associated with each pulse (e.g., using a bar representing each pulse that varies in length). For example, as illustrated in FIG. 3, the vibration pattern assigned to email messages includes a long vibration pulse, a short vibration pulse, a long vibration pulse, and a pause. It should be understood that different numbers of pulses can be included in a vibration pattern and, in some embodiments, a user can select a particular number of pulse for individual vibration patterns through the control application 120.

As illustrated in FIG. 3A, to set or modify a vibration pattern assigned to a particular message type, the graphical user interface can include a dial or other selection mechanism that presents a list of available vibration patterns that a user can select from. Alternatively or in addition, the graphical user interface can include a selection mechanism for each vibration pulse that allows a user to build a specific vibration pattern one pulse at a time. Also, in some embodiments, as illustrated in FIG. 3A, the graphical user interface provided by the control application 120 allows a user to sample a vibration pattern by selecting a play button 124. It should also be understood that, in some embodiments, one or more default vibration patterns can be assigned to particular message types. However, in some embodiments, a user can modify the default patterns through the control application 120.

As illustrated in FIG. 3, the message types that can be assigned a vibration pattern can include notifications from third-party applications. For example, a user can set a vibration pattern for notifications associated with a particular social media application (e.g., Facebook®, Twitter®). Similarly, in some embodiments, a user can set a vibration pattern for alerts generated by the mobile communication device 100, such as alerts associated with a low battery condition or a loss-of-communication between the mobile communication device 100 and the second network 250. Also, in some embodiments, the control application 120 allows a user to set a vibration pattern for specific contacts stored in the memory 114 of the mobile communication device 100. For example, a user can assign a specific vibration pattern to a family member or to a work contact. Setting a unique vibration pattern to a particular contact, allows a user to quickly identify a sender of a message (e.g., a caller) without even looking at the mobile communication device 100 or the wearable communication device. Accordingly, the term “message type,” as used in the present application, includes messages from different sources or individuals. Also, in some embodiments, a user can create a vibration pattern that also includes sounds, lights, and/or other graphics. Furthermore, in some embodiments, a user can create a pattern for a particular message type that does not include vibration pulses but includes a particular pattern of sounds, lights, and/or other graphics. All of these different types of patterns can be set through the control application 120.

In some embodiments, a vibration pattern is associated with a number of cycles. The number of cycles indicates how many times the pattern is performed by the wearable communication device 300. The number can be 1 when the pattern is performed once. The number can be greater than 1 when the pattern is repeated. Also, in some embodiments, the number of cycles can be based on the received message type or a specific received message. For example, in some embodiments, when a telephone call is received at the mobile communication device 100, the associated notification generated on the wearable communication device 300 can be repeated until the call ends (e.g., until a user answers the telephone call, the caller cancels the call, or the call goes to voicemail). Also, in some embodiments, regardless of the number of cycles assigned to a particular pattern, a user can activate input elements of the mobile communication device 100 and/or the wearable communication device 300 (described below) to stop the notification. In some embodiments, the number of cycles for one or more message types can be set to default values. However, in some embodiments, a user can configure the number of cycles for one or more message types through the control application 120. Similarly, in some embodiments, a user can use the control application 120 to set how a vibration pattern can be stopped or that a vibration pattern cannot be stopped.

It should be understood that in some embodiments, the pattern set for a particular message type can be performed only by the wearable communication device 300 (e.g., to allow different types of notifications to be generated on the device 300 than on the device 100 for the same message). However, in other embodiments, the pattern set for a particular message type can be performed both by the wearable communication device 300 and by the mobile communication device 100. Furthermore, in some embodiments, a current setting of the device 100 and/or 300 trumps a pattern generated for a particular message. For example, if the device 100 and/or 300 is set to a silent mode or a do-not-disturb mode, the device 100 and/or 300 can be configured to refrain from generating a notification as specified by the pattern or automatically modify the notification to conform the notification to the device setting (e.g., by eliminating non-vibration portions from a pattern when the device 100 and/or 300 is set to a silent mode).

Accordingly, as described above, the user accesses the control application 120 through the mobile communication device 100 to view and assign vibration patterns for particular message types. Using the mobile communication device 100 to configure these patterns takes advantage of the larger display 112 and larger and potentially increased number of input elements 106 included in the mobile communication device 100 as compared to the wearable communication device 300. Accordingly, the small size and limited functionality of the wearable communication device 300 creates a technical problem that the control application 120 address by allowing a user to configure a pattern for a particular message type remote from the wearable communication device.

After a user set patterns for particular message types, the control application 120 stores the vibration patterns with the associated message types and, in some embodiments, forwards the vibration patterns and associated message types to the wearable communication device 300. The wearable communication device 300 stores the received patterns and associated message types and uses the stored patterns and associated message types to automatically determine what vibration pattern (if any) to generate when the device 300 is notified of receipt of a particular type of message at the mobile communication device 100. Alternatively, as described below in more detail, the control application 120 can be configured to determine a message type of a message received at the mobile communication device 100, identify any vibration pattern associated with the identified message type (based on the stored information), and forward a notification to the wearable communication device 300 that informs the device 300 of the vibration pattern to generate.

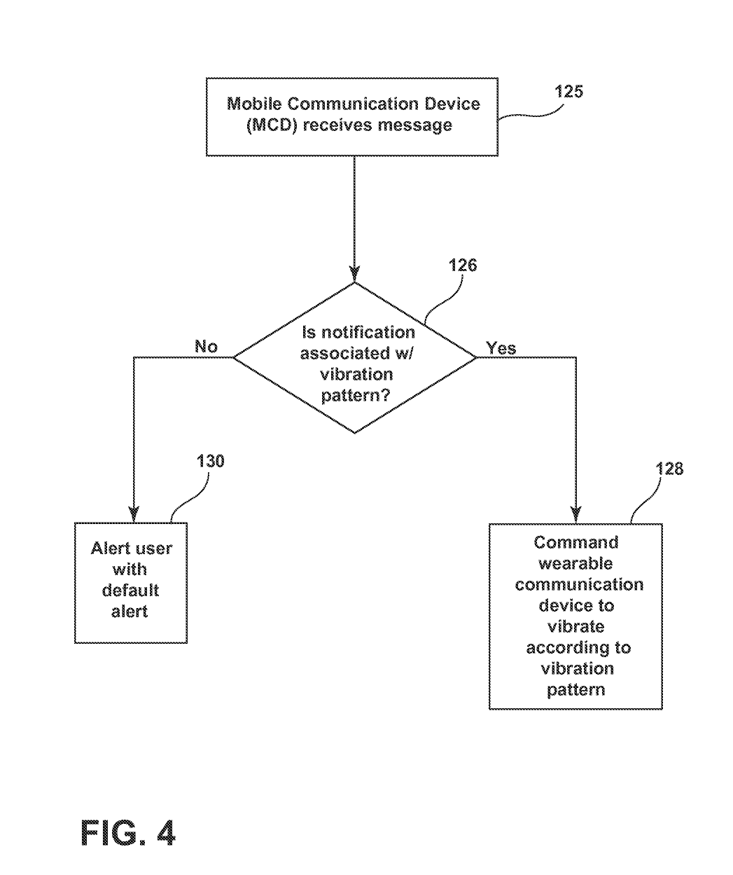

For example, FIG. 4 is a flowchart illustrating one method for providing vibration patterns on the wearable communication device 300. At block 125, the mobile communication device 100 obtains a message (e.g., over a network or by generating a message itself). Using the information stored on the mobile communication device 100, the control application 120 determines whether a notification should be provided to the wearable communication device 300 for the message and, if so, what type of notification (e.g., what pattern) should be generated at the device 300 (at block 126). If the control application 120 determines that a notification should be transmitted to the device 300, the control application 120 sends a command to the wearable communication device 300 to generate vibrations according to the vibration pattern assigned to the message type (at block 128). In some embodiments, if a particular message type is associated with notifications at the device 300 but no specific pattern is specified for the message type, the control application 120 can command the wearable communication device 300 to alert the user using default alert, which can include vibrations, sounds, and/or lights (at block 130). Alternatively, if no pattern is associated with the type of the received message, the control application 120 can be configured to not notify the wearable communication device 300 of the message. Accordingly, using the method illustrated in FIG. 4, the wearable communication device 300 is commanded by the control application 120 to vibrate in a certain pattern without determining why the vibration is occurring. For example, in some embodiments, the association between the vibration pattern and the message type is not stored on the wearable communication device 300.

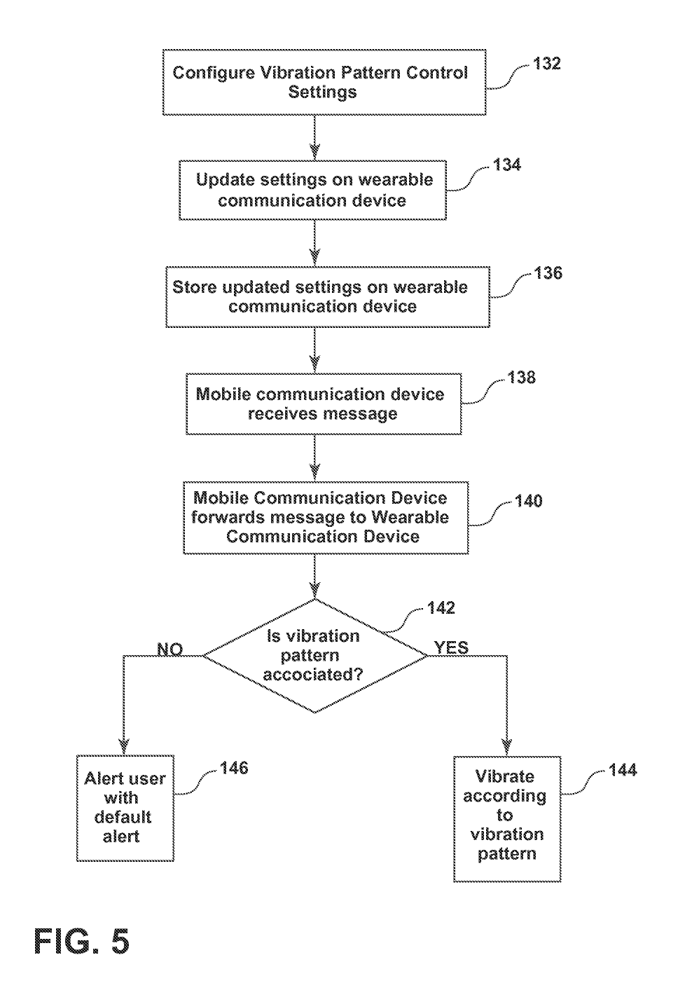

FIG. 5 is a flowchart illustrating an alternative method for providing vibration patterns on the wearable communication device 300. At block 132, the user configures the settings for the vibration patterns through the control application 120 as described above with respect to FIGS. 3 and 3A. After the configuration is complete, the control application 120 communicates with the wearable communication device 300 to provide the user-specified vibration patterns and the associated message types (at block 134). The wearable communication device 300 stores the received patterns and associated message types (at block 136). Thereafter, when the mobile communication device 100 obtains a message (at block 138), the mobile communication device 100 (e.g., through the control application 120) provides a notification to the wearable communication device 300 that, among other information, informs the device 300 of the message type (at block 140). Based on the received message type and the stored information, the wearable communication device 300 determines if a vibration pattern is associated with the type of message received from the mobile communication device 100 (at block 142). If the wearable communication device 300 determines that a vibration pattern is associated with the message type, the wearable communication device 300 performs the vibration pattern (at block 144). If, on the other hand, the wearable communication device 300 determines that no vibration pattern is associated with the message type, the wearable communication device 300 can alert the user in a default manner (e.g., using a speaker, a light, or another indicator) or not alert the user of the received message (at block 146). Accordingly, using the method illustrated in FIG. 5, the wearable communication device 300 determines if the message is associated with a vibration pattern rather than receiving commands from the control application 120 to vibrate in a certain pattern.

In some embodiments, the vibration patterns can be provided using a combination of the methods illustrated in FIGS. 4 and 5. For example, some vibration pattern settings can be stored on the wearable communication device 300 and other notifications or vibration pattern settings can be stored and managed by the mobile communication device 100.

In some embodiments, the control application 120 can also be accessed through a computing device separate from the mobile communication device. For example, the control application 120 can be accessed through a website accessible by any device connected to the Internet and providing a browser application (e.g., a desktop computer, laptop computer, tablet computer, etc.). When changes to the vibration settings are made through the website, the changes are uploaded to the mobile communication device 100 and/or the wearable communication device 300.

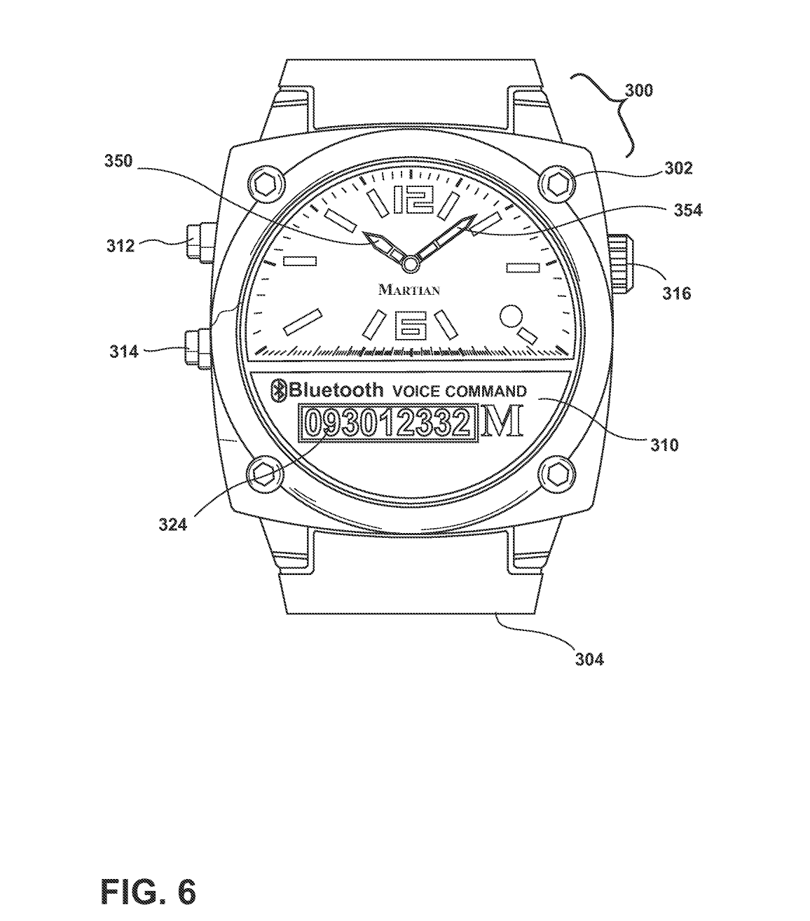

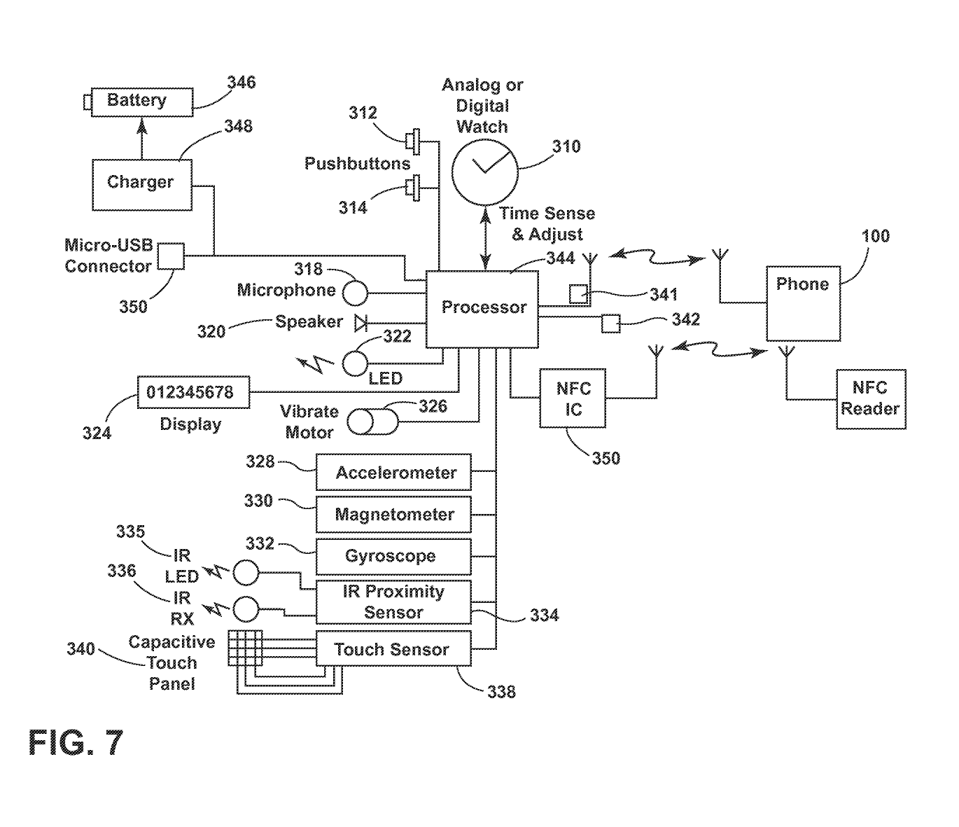

The wearable communication device 300 can be a smartwatch configured to communicate with the mobile communication device 100. As shown in FIG. 6, the wearable communication device 300 includes a main housing 302 and an attachment device configured to couple the main housing 302 to a user (e.g., a wristband 304). The wearable communication device 300 is configured to receive sound input and transmit sound (e.g., allowing a user to talk and listen through the wearable communication device 300), send and receive text messages, receive voice commands to initiate a mobile search for information, and be notified of incoming calls, text message, and other notifications when the mobile communication device 100 receives or generates messages. As shown in FIG. 7, the main housing 302 includes a watch display 310, a first push button 312, a second push button 314, a rotating knob 316, a microphone 318, a speaker 320, an indicator 322, a digital display 324, a vibrate motor 326, an accelerometer 328, a magnetometer 330, a gyroscope 332, an infrared sensor 334 coupled to an infrared LED 335 and in infrared receiver 336, a touch sensor 338 coupled to a capacitive touch panel 340, a first wireless transceiver 341, a second wireless transceiver 342, and a processor 344. The wearable communication device 300 also includes a battery 346 coupled to a charger 348 and a micro-USB connector 350 configured to receive a charging cable to charge the battery 346.

The watch display 310 is an always-on display for showing the time. As with regular watches, the watch display 310 does not need to be activated by the push of a button or any other means. Rather, the watch display 310 shows the time as long as the battery 346 supplies enough power. In the illustrated embodiment of FIG. 6, the watch display 310 is an analog display including clock hands 352, 354. In other embodiments, a digital display can be used instead or in combination with the analog display. In the illustrated embodiment, the rotating knob 316 is mechanically coupled to the clock hands 352, 354 such that rotation of the knob 316 moves the clock hands 352, 354 to adjust the current time displayed on the watch display 310. The watch display 310 is also coupled to the processor 344 such that the analog display can be adjusted according to signals from the processor 344. The processor 344 can also be configured to determine the position of the clock hands 352, 354, which allows the processor 344 to accurately set the watch display 310 according to received time information.

The first push button 312 and the second push button 314 can be programmable buttons that a user can configure using the control application 120. Pre-programmed configurations can include activate voice recognition, call last number dialed, read new text message, send new text message, and the like. In some embodiments, the first push button 312 and the second push button 314 can initiate different actions depending on the duration of activation (i.e., how long the push button is pressed) and the number of activations (i.e., the number of times the push buttons 312, 314 is pressed). Combined activations of the first push button 312 and the second push button 314 (e.g., pressing both buttons at once) can result in yet another action by the wearable communication device 300.

The microphone 318 and the speaker 320 are coupled to the processor 344. The microphone 318 and the speaker 320 enable two-way communication through one of the first network 200 and the second network 250. For example, when an incoming call is received by the mobile communication device 100, the wearable communication device 300 alerts the user of the incoming call. The user can then accept the call by pressing one of the first push button 312 and the second push button 314 or by any other means. Once the call is accepted, two-way communication is enabled through the wearable communication device 300 by using the microphone 318 and the speaker 320. The speaker 320 can also be used to alert the user of a message received at the mobile communication device 100. The message can be associated with an incoming call, an incoming text message, an incoming e-mail, a notification from a third-party application, and the like. The microphone 318 can also be used to receive voice commands. The voice commands can be applicable to the wearable communication device 300 (e.g., change the clock time to 3:00 P.M.) or they can be applicable to the mobile communication device 100 (e.g., post a comment or status on a social application). The processor 344 determines when the microphone 318 and the speaker 320 are activated. The microphone 318 and the speaker 320 can be activated automatically by the processor 344 when certain actions take place (e.g., immediately after accepting a call) and in other instances, the microphone 318 and the speaker 320 can be activated by a user input (e.g., by the activation of one of the first push button 312 and the second push button 314). The speaker 320 can also be activated by the processor 344 when the processor detects an abnormal condition of the wearable communication device 300. For example, the processor can detect the abnormal condition when the processor 344 fails to establish a communication link with the mobile communication device 100.

The indicator 322 is also coupled to the processor 344. The indicator 322 can be a multi-color or single-color light emitting diode (“LED”). The processor 344 activates the indicator 322 to alert the user of a message through the mobile communication device 100. The LED can light different colors depending on the message type. For example, if a received message is associated with an incoming call, the LED can light up blue. If a received message is associated with an incoming text, the LED can light up red. In some embodiments, rather than or in addition to changing colors, the LED changes lighting frequency depending on a message type. For example, if a received message is associated with an incoming call, the LED can light up blue and flash fast. If, on the other hand, the wireless message is associated with an incoming text message, the LED can light up red and flash slowly. In still other embodiments, however, the color of the LED does not change depending on the message type. The LED can also be activated when the wearable communication device 300 detects an abnormal condition, as described above with respect to the speaker 320. As noted above, in some embodiments, a user can configure operation of the LED through the control application 120.

The digital display 324 can be an OLED display and an RGB, or another color space LED light. In other embodiments, an LCD display, as for example, the shown one line LCD dot matrix as shown in FIG. 6 can be used. The digital display 324 is coupled and controlled by the processor 344. The digital display 324 can display a phone number for a received call, as well as other alphanumeric messages, icons, and the like.

The vibrate motor 326 is also coupled to the processor 344 and configured to be activated when the processor 344 alerts a user of a message received through the mobile communication device 100. The vibrate motor 326 can vibrate to alert the user as long as it is instructed by the processor 344.

The first wireless transceiver 341 is coupled to the processor 344. The first transceiver 341 can be a chip or any other device configured to send and receive wireless signals to and from the mobile communication device 100 using for example Bluetooth® standard, or another comparable standard. Bluetooth is a proprietary open wireless technology standard for exchanging data over short distances (using short-wavelength radio transmission in the ISM band) creating personal area networks with high levels of security without the need for a user to input a password or a passcode. The first wireless transceiver 341 can be configured to communicate with the mobile communication device 100 through the control application 120 or bypassing the control application 120. For example, when the mobile communication device 100 receives a message, the message can be processed by the control application 120 and then sent to the wearable communication device 300. In other situations, a received message is not sent to the control application 120 before being sent to the wearable communication device 300.

The second wireless transceiver 342 is also coupled to the processor 344 and to the sensors 328, 330, 332, 334, 338. In the some embodiments, one the sensors 328, 330, 332, 334, 338 is located separate from the processor 344 (e.g., in a second housing coupled to the wristband 304 opposite the main housing 302), so they communicate with the processor 344 by way of wireless signals to the second wireless transceiver 342. In some embodiments, the first wireless transceiver 341 is also configured to communicate with the sensors 328, 330, 332, 334, 338. In other embodiments, the sensors 328, 330, 332, 334, 338 are positioned close to the processor 344 and are connected to the processor 344 without the need for the second wireless transceiver 342.

The processor 344 is coupled to the second transceiver 342 and configured to receive signals received by the second wireless transceiver 342 regarding the state of the sensors 328, 330, 332, 334, 338. The signals associated with the sensors 328, 330, 332, 334, 338 provide information to the processor 344 about the movement of the wearable communication device 300 and indicate various user inputs. In some embodiments, motion of a user's hand can indicate that the user wants to activate voice command, view text messages, or perform another function. The sensors 328, 330, 332, 334, 338 can provide the processor 344 with information regarding the motion of the user's hand such that the desired action is executed by the processor 344. The accelerometer 328, the magnetometer 330, the gyroscope 332, and the infrared proximity sensor 334 all provide information regarding the position and movement of a user's wrist and/or hand. That information is then sent to the processor 344 and an appropriate action is executed by the processor 344. The touch sensor 338 is coupled to the capacitive touch panel 340 to detect when a user has touched the touch sensor 338. The touch sensor 338 can be coupled to a surface protecting the watch display 310, or in other embodiments, can be separate from the watch display 310.

The processor 344 is coupled to the first transceiver 341 and is configured to receive wireless signals originating from the mobile communication device 100. These wireless signals can be associated with an incoming call, an incoming text message, an incoming e-mail, an incoming notification from a third-party application, and the like. The processor 344 can store (e.g., in non-transitory computer-readable medium associated with the processor 344) settings for the wearable communication device 300 that determine how a user is alerted regarding each type of received message. For example, the processor 344 can store setting indicating that when an incoming call is received through the mobile communication device 100, the LED lights up green. The settings stored in the processor 344 can also include the vibration pattern settings set by a user through the control application 120 as described above. Accordingly, the processor 344 can be configured to determine a message type (e.g., an incoming communication message, a social message, a message from a third-party application, etc.) and activate the vibrate motor 326 according to the vibration pattern setting associated with the determined message type. In some embodiments, as described above, the mobile communication device 100 sends a wireless signal to the processor 344 to activate the vibrate motor 326. In such embodiments, the processor 344 does not determine a message type but rather activates the vibrate motor 326 according to instructions received from the mobile communication device 100.

By implementing the vibration patterns on the wearable communication device 300, a user is able to immediately recognize a message type without the need to look at the wearable communication device 300 or the mobile communication device 100. If the user determines that the message is important, the user can then respond accordingly. If, on the other hand, the user determines that the message is not important, the user can ignore the vibrations. When the processor 344 implements the vibration pattern settings for notifying a user, the processor 344 can also silence the speaker 320 so as to inhibit any sound notification to the user. In this manner, the vibration pattern notification serves as a silent and detailed notification to the user of any message. However, as noted above, in some embodiments, the vibration pattern notifications can be combined with a sound notification through the speaker 320 and/or a light notification through the indicator 322.

In some embodiments, such as the one illustrated in FIG. 7, the wearable communication device 300 also includes a near-field communication chip 351. The near-field communication chip 351 can enable “bump” features to transfer data from the mobile communication device 100 to the wearable communication device 300. In some embodiments, the wearable communication device 300 can also include a GPS module to determine the location of the wearable communication device 300. In some embodiments, the wearable communication device 300 tracks the location of the wearable communication device 300 and transmits location information to the mobile communication device 100. The control application 120 can allow a user to access current and previous location information for the wearable communication device 300.

The wearable communication device 300 can also perform other features such as, accessing voice command functions for a connected mobile communication device 100, placing calls, send messages, set calendar notifications, and use all other voice command functions for controlling music, and the such.

Also, it should be understood that the wearable communication device 300 can include other types of wearable devices than smartwatches and, in some embodiments, the wearable communication device 300 does not include the watch display 310. Furthermore, in some embodiments, the watch display 310 is separable from the wristband 304. In such embodiments, the wristband 304 can include the processor 344, the transceiver 341, and other components described above for generating vibration patterns and other types of alerts but does not output the current time. Rather, the wristband 304 can include a coupling interface for coupling the wristband 304 with a separate watch display, such as a fashion watch. Accordingly, in such embodiments, the user can have more control over the overall look and design of the watch display while also having access to the wireless communication capabilities provided by the wristband 304. Alternatively, the wristband 304 can communicate with the mobile communication device 100 and does not need to be coupled to any watch display.

Thus, the invention provides, among other things, a method for notifying a user of a message using a wearable communication device and configuration the notification through a mobile communication device communicating with the wearable communicate device.

Various features and advantages of the invention are set forth in the following claims.

What is claimed is:

1. A wearable communication device comprising:
an attachment device configured to couple the wearable communication device to a user;
a wireless transceiver configured to communicate with a mobile communication device, the wireless transceiver including a short-range transceiver;
a vibrate motor; and
a processor coupled to the wireless transceiver and the vibrate motor, the processor being configured to
receive from the mobile communication device, through the wireless transceiver, a first vibration pattern and a first message type associated with the first vibration pattern and a second vibration pattern and a second message type associated with the second vibration pattern,
store the first vibration pattern and the associated first message type and the second vibration pattern and the associated second message type in memory included in the wearable communication device,
receive a message from the mobile communication device through the wireless transceiver,
when a type of the received message is the first message type, access the stored first vibration pattern and operate the vibrate motor according to the first vibration pattern, and
when the type of the received message is the second message type, access the stored second vibration pattern and operate the vibrate motor according to the second vibration pattern.

2. The wearable communication device of claim 1, wherein the first vibration pattern includes a plurality of vibration pulses, each of the plurality of vibration pulses being defined by a vibration length.

3. The wearable communication device of claim 1, wherein the first message type includes one of the group consisting of a received telephone call, a missed telephone call, a received text message, an application notification message, and a status message.

4. A method of generating a notification by a wearable communication device, the method comprising:
receiving from a user, by a mobile communication device, a first vibration pattern for a first message type and a second vibration pattern for a second message type;
storing, by the mobile communication device, the first vibration pattern associated with the first message type and the second vibration pattern associated with the second message type;
receiving, by the mobile communication device, a message;
determining, by the mobile communication device, a type of the received message; and
transmitting a command to the wearable communication device, wherein, when the type of the received message is the first message type, the command instructs the wearable communication device to perform the first vibration pattern and, when the type of the received message is the second message type, the command instructs the wearable communication device to perform the second vibration pattern,
wherein, the association between the first vibration pattern and the first message type and the association between the second vibration pattern and the second message type is not stored on the wearable communication device.

5. The method of claim 4, wherein receiving the first vibration pattern includes receiving a vibration length for each of a plurality of vibration pulses.

6. The method of claim 4, wherein receiving the first vibration pattern includes displaying, on the mobile communication device, a list of available vibration patterns and receiving a selection of the first vibration pattern from the list of available vibration patterns.

7. The method of claim 4, wherein receiving the first vibration pattern includes displaying on the mobile communication device a selection mechanism for each of a plurality of vibration pluses, each selection mechanism allowing the user to select a vibration length for one of the plurality of vibration pulses, wherein the first vibration pattern includes a combination of the vibration length selected for each of the plurality of vibration pulses.

8. The method of claim 4, wherein receiving the first vibration pattern includes allowing the user to select a number of pulses included in the first vibration pattern.

9. The method of claim 4, wherein receiving the first vibration pattern includes allowing the user to select a number of cycles for the first vibration pattern, wherein the number of cycles indicates a number of times the first vibration pattern is performed by the wearable communication device.

10. The method of claim 4, further comprising, when the type of the received message is the first message type, performing a pattern different than the first vibration pattern by the mobile communication device.

11. The method of claim 4, wherein transmitting the command includes transmitting the command over a short-range communication network.

12. The method of claim 4, wherein transmitting the command includes transmitting the command over a first network and wherein receiving the message includes receiving the message over a second network.

13. The method of claim 4, where receiving the first vibration pattern for the first message type includes receiving the first vibration pattern for one of the group consisting of a received telephone call, a missed telephone call, a received text message, an application notification message, and a status message.

14. The method of claim 4, wherein receiving the first vibration pattern for the first message type includes receiving the first vibration pattern for a first contact and wherein receiving the second vibration pattern or the second message type includes receiving the second vibration pattern for a second contact.

15. A communication system comprising:
a mobile communication device including
a display,
a first transceiver, and
a first processor configured to
provide access to a graphical user interface through the display,
receive a message type from a user through the graphical user interface,
receive a vibration pattern for the message type from the user through the graphical user interface, and
when the mobile communication device obtains a message have the message type, transmit a notification to a wearable communication device using the first transceiver; and
the wearable communication device including
a second transceiver configured to receive the notification,
a vibrate motor, and
a second processor configured to perform the vibration pattern using the vibrate motor in response to receiving the notification.

16. The system of claim 15, wherein the first processor is further configured to transmit the message type and the vibration pattern to the wearable communication device using the first transceiver prior to receiving the message and wherein the second processor is configured to store the message type and the vibration pattern in memory included in the wearable communication device.

17. The system of claim 16, wherein the notification includes the message type and the second processor is configured to retrieve the vibration pattern from memory based on the message type.

18. The system of claim 15, wherein the notification includes a command to perform the vibration pattern.

19. The system of claim 15, wherein the vibration pattern includes a plurality of vibration pulses, each of the plurality of vibration pulses being defined by a vibration length.

20. The system of claim 15, wherein the wearable communication device includes a coupling interface for coupling a watch display to the wearable communication device.
